(19) United States
(12) Patent Application Publication
(10) Pub. No.: US 2025/0304062 A1
(43) Pub. Date: Oct. 2, 2025

(54) CONTROL DEVICE, AND CONTROL METHOD

(71) Applicant: HONDA MOTOR CO., LTD., Tokyo (JP)

(72) Inventor: Haruhiko Nishiguchi, Tokyo (JP)

(21) Appl. No.: 19/058,073

(22) Filed: Feb. 20, 2025

(30) Foreign Application Priority Data
Mar. 28, 2024 (JP) 2024-054675

(51) Int. Cl. B60W 30/14; B60W 50/14

(52) U.S. Cl. CPC B60W 30/143; B60W 50/14; B60W 2520/10; B60W 2552/30; B60W 2554/4042; B60W 2720/10

(57) ABSTRACT

A control device acquires a target speed during traveling on a curved road located in front of a vehicle, determines whether or not a speed of the vehicle or an object speed is less than or equal to a predetermined value with respect to the target speed, wherein the object speed is a set speed of automated speed control for automatically controlling the speed of the vehicle, and suppresses a process of causing an output device to output information indicating a proposal for gripping a steering wheel of the vehicle to a driver of the vehicle when the object speed is less than or equal to the predetermined value with respect to the target speed.

### CROSS-REFERENCE TO RELATED APPLICATION

Priority is claimed on Japanese Patent Application No. 2024-054675, filed Mar. 28, 2024, the content of which is incorporated herein by reference.

### BACKGROUND

### Field of the Invention

The present invention relates to a control device, and a control method.

### Description of Related Art

In recent years, efforts to provide sustainable transportation systems that take into account various situations have become active. For this realization, research and development aims to further improve traffic safety and convenience through research and development of driving assistance technology. Conventionally, a travel control device of a vehicle that controls a target vehicle speed in accordance with a gripping state of a steering wheel at the time of traveling on a curve has been disclosed (Japanese Unexamined Patent Application, First Publication No. 2017-144776). This travel control device is configured to ensure that the above-described control does not cause any discomfort to an occupant of the vehicle.

### SUMMARY

However, the above-described travel control device has taken into account a process of providing information corresponding to a situation to a driver. The above-described travel control device does not adequately account for the occupant and fails to significantly contribute to the development of a sustainable transportation system.

The present invention has been made in consideration of such circumstances, and an objective of the present invention is to provide a control device, and a control method for enabling information corresponding to a situation to be provided for an occupant (e.g., a driver) of a vehicle. By extension, it can contribute to the development of a sustainable transportation system by accounting for the occupant.

A control device, a control method, and a storage medium according to the present invention adopt the following configurations.
(1): According to an aspect of the present invention, there is provided a control device including: a storage medium storing computer-readable instructions; and one or more processors connected to the storage medium, the processor executing the computer-readable instructions to: acquire a target speed during traveling on a curved road located in front of a vehicle, determine whether or not a speed of the vehicle or an object speed is less than or equal to a predetermined value with respect to the target speed, wherein the object speed is a set speed of automated speed control for automatically controlling the speed of the vehicle, and suppress a process of causing an output device to output information indicating a proposal for gripping a steering wheel of the vehicle to a driver of the vehicle when the object speed is less than or equal to the predetermined value with respect to the target speed.
(2): In the above-described aspect (1), the processor executes the computer-readable instructions to: cause the vehicle to travel on the curved road at a first speed when the vehicle travels on the curved road in a gripping state in which the driver is gripping the steering wheel, and cause the vehicle to travel on the curved road at a second speed lower than the first speed when the vehicle travels on the curved road in a non-gripping state in which the driver is not gripping the steering wheel, and the target speed is the second speed corresponding to the non-gripping state or a speed based on the second speed.
(3): In the above-described aspect (2), the processor executes the computer-readable instructions to: determine whether or not the set speed is greater than or equal to a first predetermined value with respect to the target speed, determine whether or not the set speed is greater than or equal to a second predetermined value with respect to the target speed, and suppress a process of causing the output device to output the information indicating the proposal for gripping the steering wheel of the vehicle to the driver of the vehicle when the set speed is not greater than or equal to the first predetermined value with respect to the target speed or when the set speed is not greater than or equal to the second predetermined value with respect to the target speed, and the first predetermined value and the second predetermined value are different speeds.
(4): In the above-described aspect (3), the second predetermined value is a speed less than the first predetermined value.
(5): In any one of the above-described aspects (1) to (4), the speed of the vehicle is a speed derived on the basis of a speed in a previous predetermined period.
(6): In any one of the above-described aspects (1) to (4), the processor executes the computer-readable instructions to: cause the output device to output the information indicating the proposal for gripping the steering wheel of the vehicle to the driver of the vehicle if it is determined that a condition in which the speed of the vehicle can be increased is satisfied when the vehicle is traveling on the curved road after the process of causing the output device to output the information indicating the proposal for gripping the steering wheel of the vehicle to the driver of the vehicle is suppressed.
(7): In the above-described aspect (6), the condition is some or all of the following conditions: (1) a condition in which there is a space for accelerating the vehicle and increasing the speed of the vehicle in front of the vehicle, (2) a condition in which a distance from a position of the vehicle to an exit of the curved road is greater than or equal to a threshold value, and (3) a condition in which a target speed of a case where the steering wheel has been gripped is greater than a target speed of a case where the steering wheel has not been gripped and the target speed of the case where the steering wheel has been gripped is greater than a current speed of the vehicle by a threshold value or more.
(8): In any one of the above-described aspects (1) to (4), the processor executes the computer-readable instructions to: suppress the process of causing the output device to output the information indicating the proposal for gripping the steering wheel of the vehicle to the driver of the vehicle when the speed of the vehicle that is the object speed is greater than the target speed and less than or equal to a first predetermined value with respect to the target speed or when the set speed of the automated speed control for automatically controlling the speed of the vehicle is greater than the target speed and less than or equal to a second predetermined value with respect to the target speed, and cause the output device to output the information indicating the proposal for gripping the steering wheel of the vehicle to the driver of the vehicle when the speed of the vehicle that is the object speed is greater than the target speed and exceeds the first predetermined value with respect to the target speed and further the set speed is greater than the target speed and exceeds the second predetermined value with respect to the target speed.
(9): According to another aspect of the present invention, there is provided a control device including: a storage medium storing computer-readable instructions; and one or more processors connected to the storage medium, the processor executing the computer-readable instructions to: execute a first determination process of determining whether or not a speed of a vehicle is greater than a target speed during traveling on a curved road located in front of the vehicle and exceeds a first predetermined value with respect to the target speed, a second determination process of determining whether or not a set speed of automated speed control for automatically controlling the speed of the vehicle is greater than the target speed and exceeds a second predetermined value with respect to the target speed, and a process of outputting information to a driver of the vehicle using an output device, cause the vehicle to travel on the curved road at a first speed when the vehicle travels on the curved road in a gripping state in which the driver of the vehicle is gripping a steering wheel of the vehicle, cause the vehicle to travel on the curved road at a second speed lower than the first speed when the vehicle travels on the curved road in a non-gripping state in which the driver is not gripping the steering wheel, suppress a process of causing the output device to output information indicating a proposal for gripping the steering wheel of the vehicle to the driver of the vehicle when a result of the first determination process or a result of the second determination process is negative, and cause the output device to output the information indicating the proposal for gripping the steering wheel of the vehicle to the driver of the vehicle when the result of the first determination process or the result of the second determination process is positive.
(10): In the above-described aspect (9), the processor executes the computer-readable instructions to: cause the vehicle to travel on the curved road at the first speed when the driver has gripped the steering wheel in accordance with the proposal, and cause the vehicle to travel on the curved road at the second speed when the driver has not gripped the steering wheel without accepting the proposal.
(11): According to yet another aspect of the present invention, there is provided a control method including: acquiring, by a computer, a target speed during traveling on a curved road located in front of a vehicle, determining, by the computer, whether or not a speed of the vehicle or an object speed is less than or equal to a predetermined value with respect to the target speed, wherein the object speed is a set speed of automated speed control for automatically controlling the speed of the vehicle, and suppressing, by the computer, a process of causing an output device to output information indicating a proposal for gripping a steering wheel of the vehicle to a driver of the vehicle when the object speed is less than or equal to the predetermined value with respect to the target speed.
(12): According to yet another aspect of the present invention, there is provided a storage medium storing a program for causing a computer to execute steps of: acquiring a target speed during traveling on a curved road located in front of a vehicle, determining whether or not a speed of the vehicle or an object speed is less than or equal to a predetermined value with respect to the target speed, wherein the object speed is a set speed of automated speed control for automatically controlling the speed of the vehicle, and suppressing a process of causing an output device to output information indicating a proposal for gripping a steering wheel of the vehicle to a driver of the vehicle when the object speed is less than or equal to the predetermined value with respect to the target speed.

According to aspects (1) to (12), the control device, control method, or storage medium can provide information corresponding to a situation to the occupant of the vehicle (e.g., the driver). For example, the vehicle travels at a higher speed when the steering wheel is being gripped than when the steering wheel is not being gripped. In a situation where traveling at a high speed is not possible, the proposal for gripping the steering wheel can be suppressed.

According to aspect (3) or (4), more appropriate control is performed by setting the first predetermined value and the second predetermined value to appropriate values. For example, a second threshold value for the speed of the vehicle is set in consideration of a change in the speed of the vehicle.

According to aspect (5), the speed of the vehicle is required to adapt to temporary changes in a speed and more appropriate control can be implemented.

According to aspect (6), the convenience for the driver is improved by making a hands-on proposal when the situation has changed to a situation where acceleration is possible on a curved road.

According to aspect (7), because it is possible to more accurately determine that the situation has changed to a situation in which acceleration is possible on the curved road, the convenience for the driver is improved.

### BRIEF DESCRIPTION OF THE DRAWINGS

FIG. 1 is a configuration diagram of a vehicle system using a vehicle control system according to an embodiment.

FIG. 2 is an explanatory diagram of speed adjustment control.

FIG. 3 is an explanatory diagram of a state of a driver and information provided via an HMI.

FIG. 4 is an explanatory diagram (Part 1) of the speed adjustment control.

FIG. 5 is an explanatory diagram (Part 2) of the speed adjustment control.

FIG. 6 is a flowchart (Part 1) showing an example of a flow of a process executed by a driving assistance device.

FIG. 7 is a flowchart (Part 2) showing the example of the flow of the process executed by the driving assistance device.

FIG. 8 is a flowchart showing an example of a flow of a process executed by the driving assistance device.

FIG. 9 is an explanatory diagram (Part 1) of a proposal condition.

FIG. 10 is an explanatory diagram (Part 2) of a proposal condition.

### EMBODIMENTS

### [Overall Configuration]

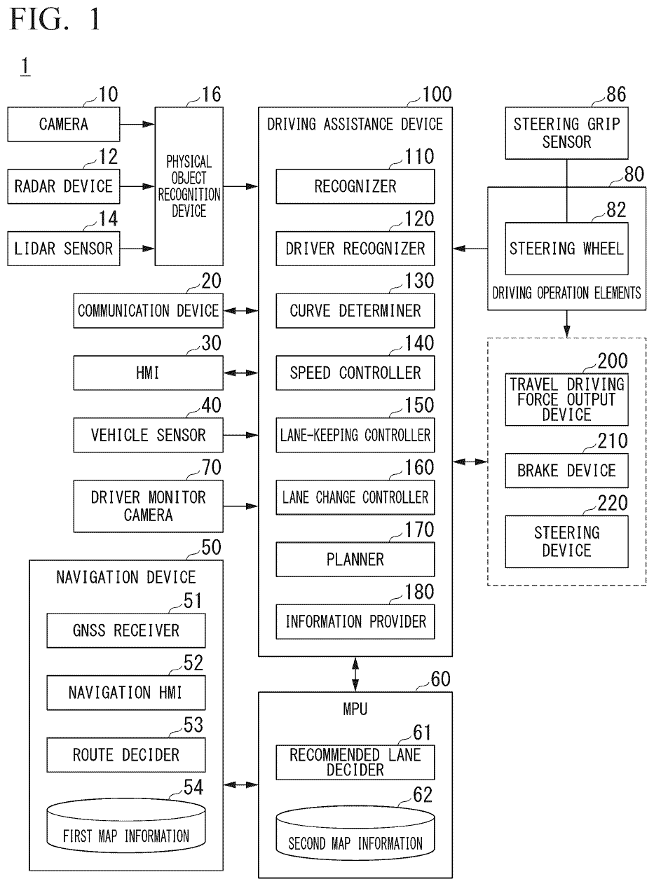

FIG. 1 is a configuration diagram of a vehicle system 1 including a vehicle control system according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, driving operation elements 80, an driving assistance device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added. The driving assistance device 100 is an example of a “vehicle control device.”

For example, the camera 10 is a digital camera using a solid-state imaging element such as, for example, a charge-coupled device (CCD) or a complementary metal oxide semiconductor (CMOS). The camera 10 is attached to any location on the vehicle (hereinafter referred to as a host vehicle M) in which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position of a physical object (a distance to and a direction of the physical object) by detecting radio waves (reflected waves) reflected by the physical object. The radar device 12 is attached to any position on the host vehicle M. The radar device 12 may detect a position and a speed of the physical object in a frequency modulated continuous wave (FM-CW) scheme.

The LIDAR sensor 14 radiates light to the vicinity of the host vehicle M (or electromagnetic waves having a wavelength close to that of light) and measures scattered light. The LIDAR sensor 14 detects a distance from an object on the basis of time from light emission to light reception. The radiated light is, for example, pulsed laser light. The LIDAR sensor 14 is attached to any location on the host vehicle M.

The physical object recognition device 16 performs a sensor fusion process on detection results from some or all of the camera 10, the radar device 12, and the LIDAR sensor 14 to recognize a position, a type, a speed, and the like of a physical object. The physical object recognition device 16 outputs recognition results to the driving assistance device 100. The physical object recognition device 16 may output detection results of the camera 10, the radar device 12, and the LIDAR sensor 14 to the driving assistance device 100 as they are. The physical object recognition device 16 may be omitted from the vehicle system 1.

The communication device 20 uses, for example, a cellular network, a Wi-Fi network, a Bluetooth (registered trademark) network, a dedicated short range communication (DSRC) network to communicate with other vehicles near the host vehicle M or communicate with various types of server devices via a radio base station.

The HMI 30 presents various types of information to an occupant of the host vehicle M and receives an input operation by the occupant. The HMI 30 includes various types of display devices, a speaker, a buzzer, a touch panel, a switch, keys, and the like. The HMI 30 includes a display device. The display device (display) is, for example, a display device, i.e., a multi-information display provided in the center of the instrument panel of the host vehicle M and configured to display various information in the host vehicle M such as a speedometer indicating a traveling speed of the host vehicle M or a tachometer indicating a rotational speed of the internal combustion engine provided in the host vehicle M.

The vehicle sensor 40 includes a vehicle speed sensor configured to detect the speed of the host vehicle M, an acceleration sensor configured to detect acceleration, a yaw rate sensor configured to detect angular velocity around a vertical axis, a direction sensor configured to detect a direction of the host vehicle M, and the like.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane decider 61 and holds second map information 62 in a storage device such as an HDD or a flash memory. The recommended lane decider 61 divides the route on the map provided from the navigation device 50 into a plurality of blocks (e.g., divides the route every 100 [m] in a traveling direction of the vehicle), and decides a recommended lane for each block with reference to the second map information 62. The recommended lane decider 61 decides in what lane numbered from the left the vehicle will travel. The recommended lane decider 61 decides the recommended lane so that the host vehicle M can travel along a reasonable route for traveling to a branching destination when there is a branch point in the route on the map.

The second map information 62 is map information that is more accurate than the first map information 54. The second map information 62 includes, for example, information about the center of the lane, information about the boundary of the lane, and the like. The second map information 62 may include road information, traffic adjustment information, address information (address/postal code), facility information, telephone number information, and the like. The second map information 62 may be updated at any time by the communication device 20 communicating with the external device.

The driver monitor camera 70 is, for example, a digital camera that uses a solid-state imaging element such as a CCD or a CMOS. The driver monitor camera 70 is attached to any location on the host vehicle M with respect to a position and a direction where the head of the occupant (hereinafter, the driver) sitting in the driver's seat of the host vehicle M can be imaged from the front (in a direction in which his or her face is imaged). For example, the driver monitor camera 70 is attached to an upper part of a display device provided on the central portion of the instrument panel of the host vehicle M. The driver monitor camera 70 outputs an image obtained by capturing the cabin including the driver of the host vehicle M from an arrangement position to the driving assistance device 100.

The driving operation elements 80 include, for example, an operation switch of a direction indicator, an accelerator pedal, a brake pedal, a shift lever, and other operation elements in addition to the steering wheel 82. A sensor for detecting an amount of operation or the presence or absence of an operation is attached to the driving operation element 80 and a detection result thereof is output to the driving assistance device 100 or some or all of the travel driving force output device 200, the brake device 210, and the steering device 220. The steering wheel 82 does not necessarily have to be annular and may be in the form of a variant steering wheel, a joystick, a button, or the like. A steering grip sensor 86 is attached to the steering wheel 82.

The steering grip sensor 86 is implemented, for example, by a capacitance sensor, a piezoelectric element, or the like. The steering grip sensor 86 detects whether or not the driver is gripping the steering wheel 82. Gripping includes a state in which the driver is gripping the steering wheel 82, a state in which the hand is in contact with the steering wheel 82, a state in which a force of a predetermined degree or higher is applied to the steering wheel 82, or the like.

The steering grip sensor 86 may detect gripping on the basis of an image captured by a camera or detect gripping using an optical method such as a radar device (a method that does not require contact with the sensor).

The driving assistance device 100 includes, for example, a recognizer 110, a driver recognizer 120, a curve determiner 130, a speed controller 140, a lane-keeping controller 150, a lane change controller 160, a planner 170, and an information provider 180. Some or all of these functional elements are implemented, for example, by a hardware processor such as a central processing unit (CPU) executing a program (software). Also, some or all of the above components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the driving assistance device 100 or may be stored in a removable storage medium such as a DVD or a CD-ROM and installed in an HDD or a flash memory of the driving assistance device 100 when the storage medium (the non-transitory storage medium) is mounted in a drive device.

On the basis of information input from the camera 10, the radar device 12, and the LIDAR sensor 14 via the physical object recognition device 16, the recognizer 110 recognizes a state of a position, velocity, acceleration, and the like of a physical object in the vicinity of the host vehicle M. The position of the physical object, for example, is recognized as a position of an absolute coordinate system having a representative point of the host vehicle M (a center of gravity, a drive shaft center, or the like) as the origin, and is used for control. The position of the physical object may be represented by a representative point such as the center of gravity or a corner of the physical object or may be represented in a region. The “state” of the physical object may include the acceleration or jerk of the physical object, or the “action state” (e.g., whether or not the lane is changing or is about to change).

Also, for example, the recognizer 110 recognizes a lane in which the host vehicle M is traveling (a travel lane). For example, the recognizer 110 recognizes the travel lane by comparing a pattern of road markings (e.g., an arrangement of solid lines and broken lines) obtained from the second map information 62 with a pattern of road markings in the vicinity of the host vehicle M recognized from an image captured by the camera 10. The recognizer 110 may recognize a travel lane by recognizing a runway boundary (road boundary) including a road marking, a shoulder, a curb, a median strip, a guardrail, and the like as well as a road marking. In this recognition, a position of the host vehicle M acquired from the navigation device 50 or a processing result of the INS may be taken into account. The recognizer 110 recognizes a temporary stop line, an obstacle, red traffic light, a toll gate, and other road events.

When the travel lane is recognized, the recognizer 110 recognizes a position or an orientation of the host vehicle M with respect to the travel lane. For example, the recognizer 110 may recognize a deviation of a reference point of the host vehicle M from the center of the lane and an angle formed between the travel direction of the host vehicle M and a line connected to the center of the lane as a relative position and orientation of the host vehicle M related to the travel lane. Alternatively, the recognizer 110 may recognize a position of the reference point of the host vehicle M related to one side end portion (a road marking or a road boundary) of the travel lane or the like as a relative position of the host vehicle M related to the travel lane.

The driver recognizer 120 detects whether or not the driver is in a predetermined state on the basis of the image captured by the driver monitor camera 70. The predetermined state is a state in which hands-off lane-keeping control to be described below is executable. Hands-off is a state in which the driver is not gripping the steering wheel 82 and hands-on is a state in which the driver is gripping the steering wheel 82. The state in which hands-off lane-keeping control can be executed is a state in which the driver is monitoring the front (or the vicinity of the host vehicle M). Forward monitoring indicates, for example, that the driver monitors the front so that the driver can quickly make a change from a state in which the vehicle system 1 controls the host vehicle M to a state in which the driver operates the host vehicle M. Forward monitoring indicates, for example, that the driver's visual line is facing forward.

The curve determiner 130 identifies the position of the host vehicle M in the map information on the basis of the map information (the first map information 54 or the second map information 62) including information related to the lane and the position of the host vehicle M. The map information includes information indicating features of the road and the travel lane. The information indicating the features includes, for example, a radius of the circle of the curve (a curve radius). The information indicating the features may include information indicating that a curved road is a curved road where “speed adjustment control” to be described below is executable. The curved road may include a road that is curved and a road in a region within a predetermined distance of the road. For example, the region within the predetermined distance is a region corresponding to a position where the host vehicle M decelerates when entering a curve.

For example, the speed controller 140 automatically controls the travel driving force output device 200 and the brake device 210 without depending on the driver's operation and automatically controls the speed of the host vehicle M. The speed controller 140 executes so-called adaptive cruise control (ACC).

For example, when there is no other vehicle within a predetermined distance from the host vehicle M in front of the host vehicle M, the speed controller 140 automatically controls the travel driving force output device 200 and the brake device 210 without depending on the driver's operation so that the host vehicle M moves at a speed set by the driver, a legal speed, and a speed preset in accordance with a road.

For example, when there is another vehicle in front of the host vehicle M and within a predetermined distance from the host vehicle M, the speed controller 140 automatically controls the travel driving force output device 200 and the brake device 210 without depending on the driver's operation to track the other vehicle. Tracking indicates that the host vehicle M is behind the other vehicle and travels while maintaining a position of a predetermined distance from the other vehicle. The speed controller 140 performs speed adjustment control to be described below.

The lane-keeping controller 150 controls the steering device 220 so that the host vehicle M does not deviate from the travel lane. For example, the lane-keeping controller 150 controls the steering device 220 so that the host vehicle M travels in the center of the travel lane recognized by the recognizer 110 or near the center. Hereinafter, this control may be referred to as “lane-keeping control.” The lane-keeping controller 150 executes hands-on lane-keeping control and hands-off lane-keeping control.

The hands-on lane-keeping control is control that is executed in a state in which the driver is gripping the steering wheel 82 (a state in which the steering grip sensor 86 has detected the gripping of the steering wheel 82). A condition under which hands-on lane-keeping control is executable is less stringent than that under which hands-off lane-keeping control is executable. For example, hands-on lane-keeping control is executed on the condition that the speed of the host vehicle M is greater than or equal to a predetermined speed and the driver is monitoring the front.

The hands-off lane-keeping control is control executable in a state in which the driver is not gripping the steering wheel 82 (a state in which the steering grip sensor 86 has not detected the gripping of the steering wheel 82). The hands-off lane-keeping control is executable, for example, when the following conditions are satisfied. The speed of the host vehicle M is greater than or equal to a predetermined speed, the host vehicle M is traveling on a predetermined road (e.g., a preset road or road type in which hands-off lane-keeping control is executable), and the driver is monitoring the front. The hands-off lane-keeping control is executed when the driver is monitoring the front and the hands-off lane-keeping control is not executed or stops when the driver is not monitoring the front.

The conditions under which the above-described hands-on lane-keeping control and hands-off lane-keeping control is executable are examples, other conditions (e.g., a condition that the host vehicle M is tracking a preceding vehicle) may be included or some conditions may be omitted. It is only necessary for the conditions under which hands-on lane-keeping control is executable to be less stringent than the conditions under which hands-off lane-keeping control is executable (or it is only necessary for the conditions under which hands-off lane-keeping control is executable to be more stringent than the conditions under which hands-on lane-keeping is executable).

The lane change controller 160 causes the host vehicle M to change lanes automatically. The lane change controller 160 causes the host vehicle M to change lanes on the basis of the destination and route set by the occupant and the recommended lane output to the MPU 60. For example, the lane change controller 160 can make a lane change when a lane change is required to go to the destination. The lane change controller 160 causes the host vehicle M to change lanes automatically (an automatic lane change (ALC)) when a lane change instruction has been issued by the driver in a state in which the hands-off lane-keeping control is executed. The lane change instruction is an operation of a lever part of the operation switch of the direction indicator. For example, if the lever part operates in a direction in which the driver desires to cause the host vehicle M to change lanes, the host vehicle M changes lanes in a direction corresponding to the operation. The lane change instruction may be an operation different from the operation of the lever part of the operation switch of the direction indicator. For example, when a predetermined operation button has been pressed, the lane change may be made.

For example, the lane change controller 160 executes a lane change when the following conditions are satisfied. The conditions are, for example, that there are no obstacles in a lane of a lane change destination, that there is no interference with other vehicles in the vicinity when the lane change is made, that there is no lane change prohibited segment (that there are no road markings or signs prohibiting the lane change), that a lane of a lane change destination is recognized (that it is real), that a yaw rate detected by the vehicle sensor 40 is less than a threshold value, that a radius of curvature of the road during traveling is greater than or equal to a predetermined value, and the like. The conditions for executing the lane change may include other conditions or some conditions may be omitted.

The lane change controller 160, for example, may execute the lane change under the condition that the driver is gripping the steering wheel 82 (or that the steering grip sensor 86 has detected the gripping of the steering wheel 82).

The planner 170 generates a plan for causing the host vehicle M to travel on the basis of a route toward a destination set by an occupant. In principle, the planner 170 generates a target trajectory along which the host vehicle M travels in the recommended lane decided by the recommended lane decider 61 and further the host vehicle M will automatically travel in the future (regardless of the driver's operation) so that it is possible to cope with a surrounding situation of the host vehicle M. The target trajectory may include, for example, a speed element. For example, the target trajectory is represented by sequentially arranging points (trajectory points) at which the host vehicle M is required to arrive. The trajectory points are points at which the host vehicle M is required to arrive for each predetermined traveling distance (e.g., about several meters [m]) along a road. In addition, a target speed and target acceleration for each predetermined sampling time (e.g., about 0.x [sec] where x is a decimal number) are generated as parts of the target trajectory. Also, the trajectory point may be a position where the host vehicle M is required to arrive at the sampling time for each predetermined sampling time. In this case, information of the target speed or the target acceleration is represented by an interval between the trajectory points.

For example, the planner 170 causes the host vehicle M to travel along a target trajectory in cooperation with the curve determiner 130, the speed controller 140, the lane-keeping controller 150, and the lane change controller 160. For example, the planner 170 generates an action plan of the host vehicle M so that the speed controller 140 controls the speed of the host vehicle M, the lane-keeping controller 150 controls steering, and the driver controls the speed, if necessary, grips the steering wheel 82, or operates the steering wheel 82 for arrival at a destination in a state in which the driver of the host vehicle M is monitoring the surroundings of the host vehicle M. For example, the planner 170 generates a plan for causing the host vehicle M to travel in an operation of the driver in a first segment and causing the host vehicle M to travel under control of the driving assistance device 100 in a second segment, and causes the host vehicle M to travel in cooperation with the driver, the curve determiner 130, the speed controller 140, the lane-keeping controller 150, and the lane change controller 160 in accordance with the plan.

The information provider 180 causes the HMI to output various types of information about the state of the host vehicle M and driving assistance by an audio or image.

The travel driving force output device 200 outputs a travel driving force (torque) for enabling the traveling of the host vehicle M to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the speed controller 140 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the speed controller 140 or the information input from the driving operation element 80 so that brake torque according to a braking operation is output to each wheel.

For example, the steering device 220 includes a steering ECU and an electric motor. For example, the electric motor changes a direction of steerable wheels by applying a force to a rack and pinion mechanism. The steering ECU drives the electric motor in accordance with the information input from the lane-keeping controller 150 or the lane change controller 160 or the information input from the driving operation element 80 to change the direction of the steerable wheels.

### [Speed Adjustment Control]

The driving assistance device 100 executes driving assistance control and controls the speed of the host vehicle M in accordance with the driver's gripping state of the steering wheel 82 during traveling on a curved road. The driving assistance control is control in which the speed controller 140 controls the speed of the host vehicle M and the lane-keeping controller 150 executes lane-keeping control in a state in which the driver is monitoring the surroundings of the host vehicle M. The driving assistance device 100, for example, causes the host vehicle M to travel at a lower speed in a case where the driver is not gripping the steering wheel 82 while the host vehicle M is traveling on a curved road than in a case where the driver is gripping the steering wheel 82 and causes the host vehicle M to accelerate or suppresses the deceleration of the host vehicle M when it is determined that the driver has gripped the steering wheel 82 in a case where the driver is not gripping the steering wheel 82 and causes the host vehicle M to travel on the curved road at a low speed. The time of traveling on a curved road, for example, may be the time of traveling on a road (lane) that is curved as a curved road or may include the time when the host vehicle M has started deceleration to enter the curved road in addition to the above.

For example, the driving assistance device 100 causes the host vehicle M to travel in a first speed plan when the driver is gripping the steering wheel 82 while the host vehicle M is traveling on a curved road and causes the host vehicle M to travel in a second speed plan when the driver is not gripping the steering wheel 82 while the host vehicle M is traveling on a curved road. If the driver is not gripping the steering wheel 82 and causes the host vehicle M to travel in the second speed plan, the driving assistance device 100 switches the plan from the second speed plan to the first speed plan and causes the host vehicle M to travel on the basis of the first speed plan when it is determined that the driver has gripped the steering wheel 82. When the driver has gripped the steering wheel 82 in a case where the speed of the host vehicle M is controlled on the basis of the second speed plan, the driving assistance device 100 decelerates or accelerates the host vehicle M to cause the speed of the host vehicle M to be consistent with the speed specified in the first speed plan. The first speed plan and the second speed plan are information indicating a change in the speed of the host vehicle M at the time of traveling on a curved road and the second speed plan is a plan for causing the host vehicle M to travel at a lower speed than the first speed plan. Hereinafter, details of the speed adjustment control will be described.

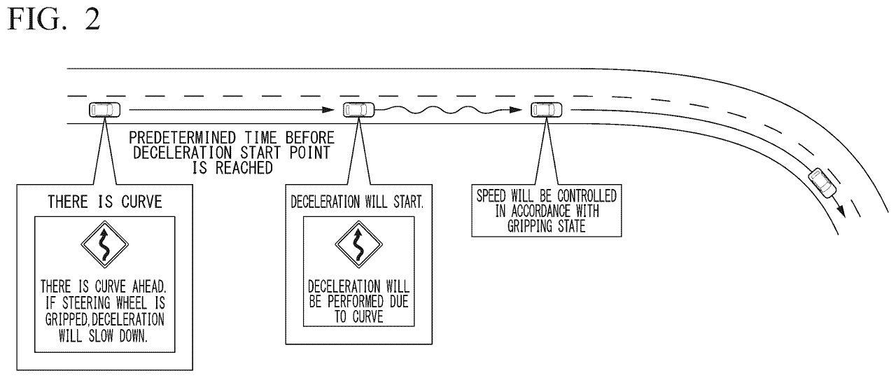

FIG. 2 is an explanatory diagram of speed adjustment control. The driving assistance device 100 provides the driver with first proposal information via the HMI 30 before the curved road is reached. The first proposal information includes, for example, that there is a curved road in front and that the deceleration of the host vehicle M slows down at the time of traveling on the curved road if the steering wheel 82 is gripped. When the host vehicle M reaches a position where deceleration starts, the driving assistance device 100 decelerates the host vehicle M.

The above-described deceleration degree and the speed of the host vehicle M are decided on the basis of the driver's gripping state of the steering wheel 82. For example, when the driver is gripping the steering wheel 82 (in a hands-on case), the driving assistance device 100 decelerates the host vehicle M at a first deceleration degree. For example, when the driver is not gripping the steering wheel 82 (in a hands-off case), the driving assistance device 100 decelerates the host vehicle M at a second deceleration degree. The second deceleration degree is a deceleration degree higher than the first deceleration degree. The host vehicle M is allowed to travel at a higher speed in the hands-on case than in the hands-off case.

In other words, the driving assistance device 100 decides the target speed in accordance with the gripping state of the steering wheel 82. For example, the target speed in the hands-on state is set to be higher than the target speed in the hands-off state.

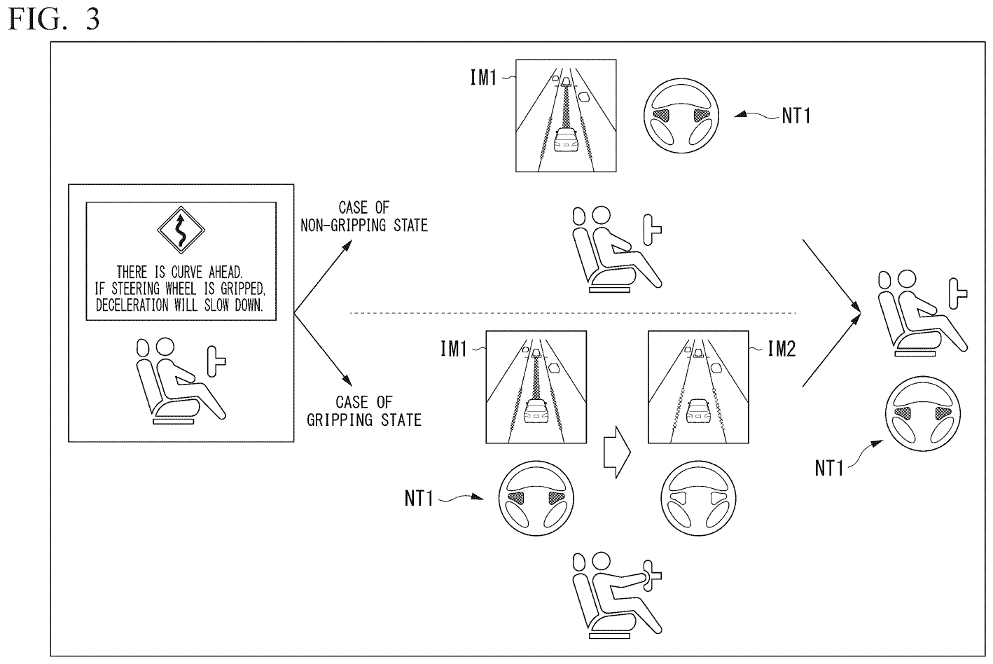

FIG. 3 is an explanatory diagram of a state of the driver and information provided via the HMI 30. For example, when the driver does not grip the steering wheel 82 in accordance with first proposal information, a first image IM is displayed and a first notification is output. The first image IM1 is information indicating that hands-off lane-keeping control is being executed. A first notification NT1 is a notification for recommending the hands-on state by emitting light in a first aspect with a light emitter provided on the steering wheel 82.

For example, when the driver has gripped the steering wheel 82 in accordance with the first proposal information, a second image IM2 is displayed instead of the first image IM1 and the output of the first notification NT1 is stopped. The second image IM2 is information indicating that hands-on lane-keeping control is being executed when the steering wheel 82 has been gripped. The driving assistance device 100 provides the driver with second proposal information via the HMI 30 and notifies the driver only about the deceleration for the curve. The second proposal information is information indicating that the host vehicle M decelerates for traveling on a curved road. Subsequently, when the host vehicle M has reached the end of the curved road or near the end, the driving assistance control (hands-off lane-keeping control) is continued or resumed.

### [Relationship Between Operation and Control at Time of Traveling on Curved Road]

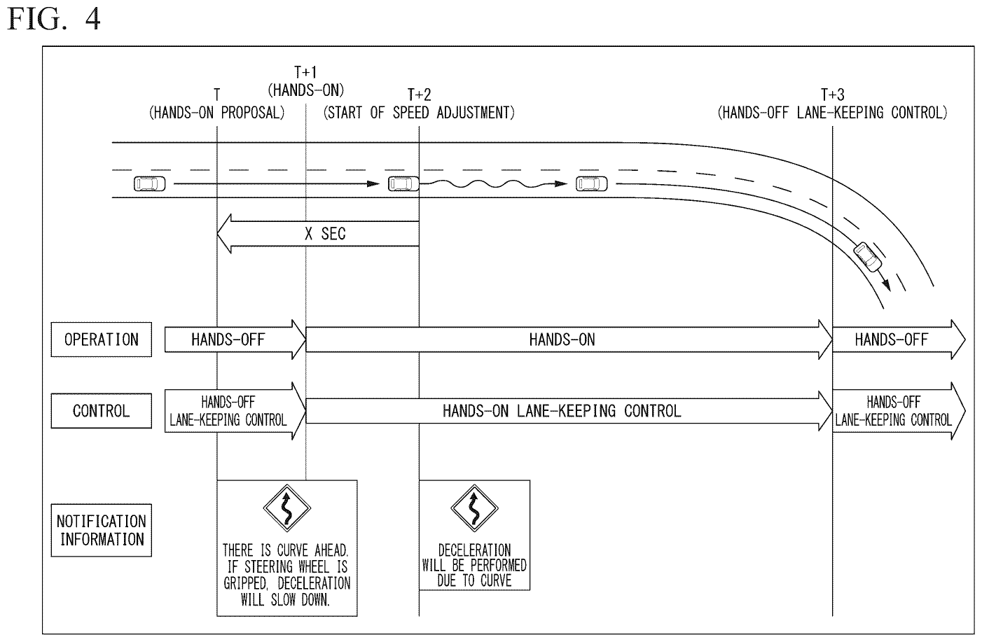

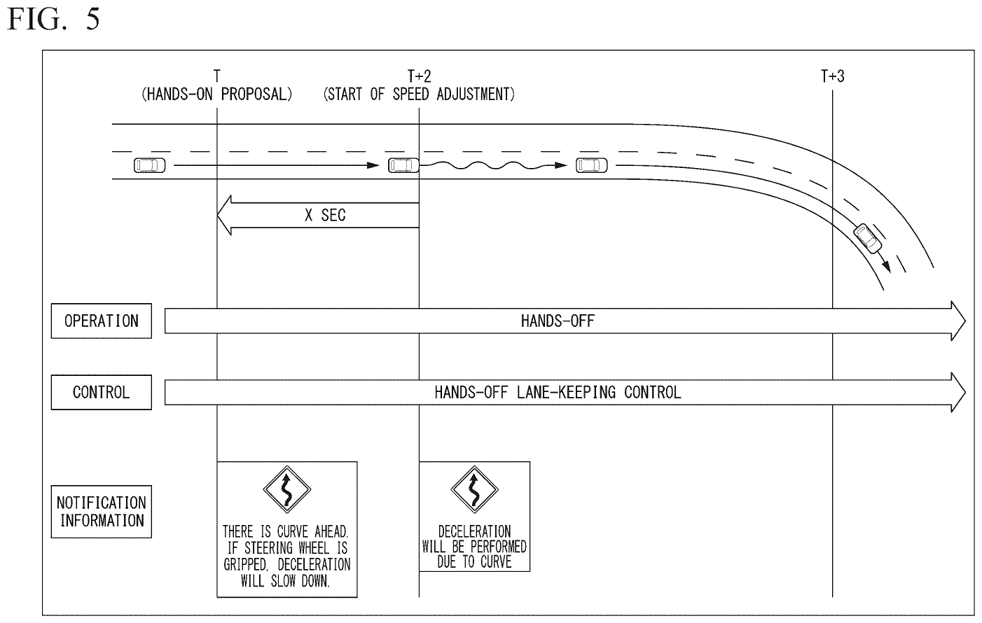

Control in the hands-on case (FIG. 4) and control in the hands-off case (FIG. 5) at the time of traveling on a curved road will be described with reference to FIGS. 4 and 5.

FIG. 4 is an explanatory diagram (Part 1) of speed adjustment control. Time T is a timepoint at which the driving assistance device 100 has made a hands-on proposal (a timepoint at which the first proposal information is provided). Time T is, for example, a timepoint that is earlier than time T+2 to be described below by a predetermined number of seconds (e.g., 5 sec, 6 sec, 7 sec, or the like). Time T may be a timepoint before a predetermined distance from time T+2.

When the driver has performed a hands-on operation at time T+1, the second proposal information is provided to the driver and the driving assistance device 100 executes the hands-on lane-keeping control instead of the hands-off lane-keeping control. At time T+2, the driving assistance device 100 starts the adjustment of the speed of the host vehicle M to cause the host vehicle M to travel on the curved road. Time T+2 is, for example, a timepoint when deceleration starts. Time T+2 is a timing when the host vehicle M has reached the entrance of the curved road or within a predetermined distance before the entrance, or the like. The entrance to the curve is, for example, a position where the road (lane) begins to curve or a position where the road has curvature greater than or equal to a threshold value. Time T+2 is a timepoint corresponding to a position decided on the basis of a shape (curvature) of the curved road, a speed of the host vehicle M, a surrounding situation, and the like.

From time T+2 to time T+3, the driving assistance device 100 controls the speed on the basis of the first speed plan. The first speed plan is a future speed change adopted when the steering wheel 82 is gripped. The first speed plan is, for example, a plan in which a maximum load on the occupant in the case of traveling on the curved road is less than a first degree. The load is, for example, acceleration. The load may be lateral acceleration for the occupant. The first degree is, for example, about 0.2 G to 0.3 G (e.g., 0.25 G).

At time T+3, the driving assistance device 100 executes the hands-off lane-keeping control instead of the hands-on lane-keeping control. Time T+3 is a timepoint when the host vehicle M has arrived at or near the exit of the curved road. The exit of the curve is, for example, a position where the road (lane) is straightened, a position where the curvature of the road is less than a threshold value, a position set in advance in the map information, and the like. After time T+3, the hands-off lane-keeping control is executed regardless of the hands-on or hands-off.

FIG. 5 is an explanatory diagram (Part 2) of speed adjustment control. The differences from the description of FIG. 4 will be mainly described. When the hands-on operation has not been performed after time T, the driving assistance device 100 continuously executes the hands-off lane-keeping control. From time T+2 to time T+3, the driving assistance device 100 controls the speed on the basis of the second speed plan. The second speed plan is a future speed change adopted when the steering wheel 82 is not gripped. The speed of the second speed plan is a plan of a change in a speed lower than the speed of the first speed plan. The second speed plan, for example, is a plan in which the maximum load on the occupant in the case of traveling on the curved road is less than a second degree. The second degree is, for example, about 0.1 G to 0.2 G (e.g., 0.15 G). As shown in FIG. 5, when the hands-off lane-keeping control is continued, the information of a notification provided at time T is continuously displayed even after time T+2.

### [Flowchart (Part 1)]

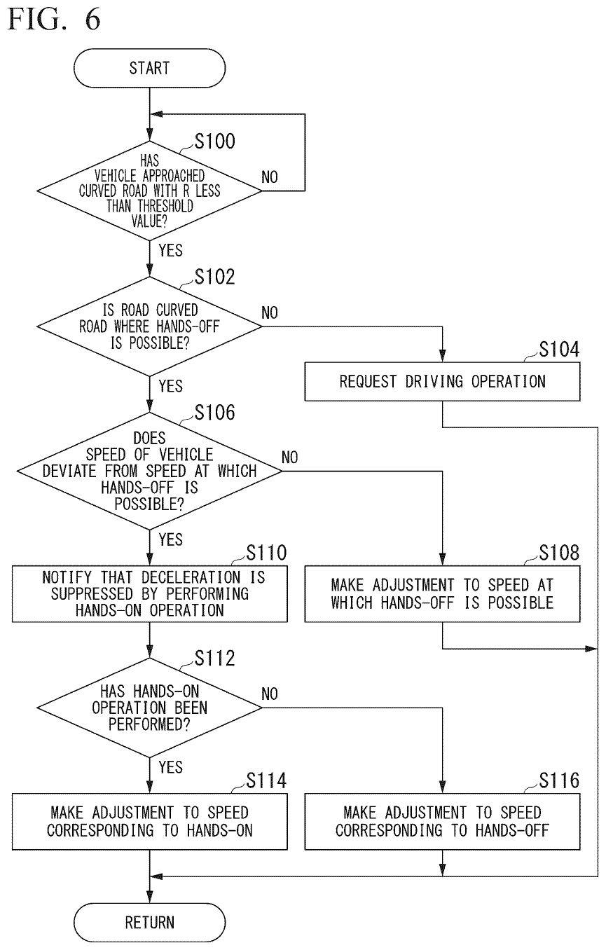

FIG. 6 is a flowchart (Part 1) showing an example of a flow of a process executed by the driving assistance device 100. First, the curve determiner 130 determines whether or not the host vehicle M has approached a curved road with R (a circular radius) of the curve less than the threshold value on the basis of the position of the host vehicle M and the map information (step S100). The approach indicates that the host vehicle M is located within a predetermined distance or that the host vehicle M reaches a curved road after a predetermined number of seconds. R is less than the threshold value, for example, R is about 200 to 400. R is less than the threshold value, for example, R is 300.

When the host vehicle M has approached the curved road with R of the curve less than the threshold value, the curve determiner 130 determines whether or not the approaching curved road is a curved road where the hands-off is possible (step S102).

When the approaching curved road is not a curved road where the hands-off is possible, the driving assistance device 100 requests the driver to perform a driving operation via the HMI 30 (S104). When a notification of this request has been provided, the host vehicle M travels on a curved road according to the driver's operation.

Information indicating whether or not the curved road is a curved road where the hands-off is possible may be stored in the map information or the driving assistance device 100 may be determined on the basis of a recognition result of the physical object recognition device 16. The curved road where the hands-off is not possible is a curved road where it is difficult to identify the position of the host vehicle M, it is difficult to recognize a road, lane, and surrounding situation on the basis of an image captured by the camera 10, or it is difficult to identify a course along which the host vehicle M travels. When R of the curved road is less than the threshold value (when the curved road is a sharp curve), it may be determined that the curved road is not a curved road where the hands-off is possible.

When the approaching curved road is a curved road where the hands-off is possible, the driving assistance device 100 determines whether or not the speed of the host vehicle M deviates from a speed at which the host vehicle M travels on the curved road in the hands-off state by a predetermined speed or more (S106). When there is no deviation of the predetermined speed or more, the driving assistance device 100 adjusts the speed of the host vehicle M to a speed of traveling on a curved road in the hands-off state on the basis of a timing when the speed adjustment starts (S108). When there is no deviation of the predetermined speed or more as described above, the speed is close to the speed at which the host vehicle M is already traveling on the curved road in the hands-off state (or close to the speed of the second speed plan). Even if the host vehicle M travels in the second speed plan of the hands-off, because there is no deviation from the sense of the occupant, the speed of the host vehicle M is controlled as described above. For example, if a traffic jam occurs or the speed of the preceding vehicle is slow, the speed of the host vehicle M may be close to the speed of the second speed plan. In this case, even if control is executed on the basis of the second speed plan, the occupant does not feel uncomfortable or the control is consistent with the occupant's sense.

When there is a deviation of a predetermined speed or more, the driving assistance device 100 notifies the driver of the first proposal information indicating that deceleration is suppressed by performing the hands-on operation (S110). Subsequently, the driving assistance device 100 determines whether or not the hands-on operation has been performed (S112). When the hands-on operation has been performed, the driving assistance device 100 adjusts the speed of the host vehicle M to a speed corresponding to the hands-on operation (S114). The driving assistance device 100 controls, for example, the speed of the host vehicle M on the basis of the first speed plan. When the hands-on operation has not been performed, the driving assistance device 100 adjusts the speed of the host vehicle M to the speed corresponding to the hands-off operation (S116). The driving assistance device 100, for example, controls the speed of the host vehicle M on the basis of the second speed plan.

As described above, the driving assistance device 100 can control the speed of the host vehicle M so that the speed becomes a speed consistent with the occupant's sense in accordance with the driver's gripping state of the steering wheel 82.

When the host vehicle M travels on a curved road (a loose curved road) where R of the curve is greater than or equal to the threshold value, the driving assistance device 100 may control the host vehicle M at a speed consistent with the driver's sense (without excessive deceleration) to execute hands-off lane-keeping control. In this case, regardless of the hands-on or hands-off, the speed of the host vehicle M may be controlled by the same speed plan.

### [Flowchart (Part 2)]

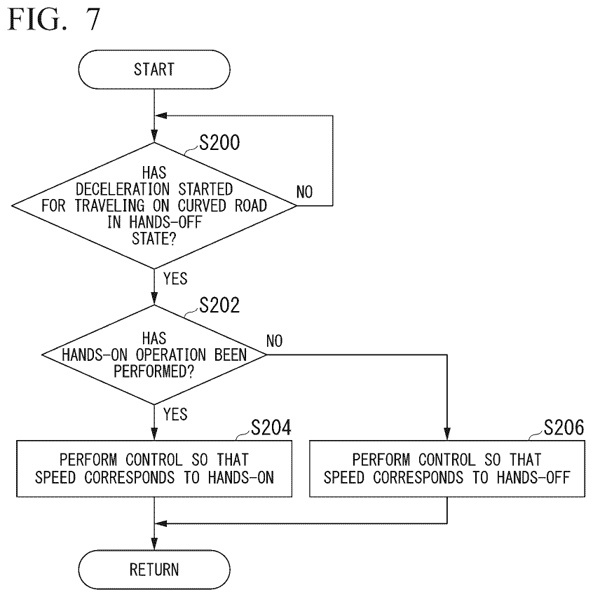

FIG. 7 is a flowchart (Part 2) showing an example of a flow of a process executed by the driving assistance device 100. This process is a process related to control of the speed when the hands-on operation is performed when the speed is adjusted on the basis of the second speed plan of the hands-off operation.

First, when the adjustment of the speed for traveling on a curved road in the hands-off state has started (step S200), the driving assistance device 100 determines whether or not the hands-on operation has been performed (S202). When the hands-on operation has been performed during a predetermined period, the driving assistance device 100 controls the speed of the host vehicle M so that the speed becomes a speed corresponding to the hands-on (a speed based on the first speed plan) (step S204). When the hands-on operation has not been performed, the driving assistance device 100 controls the speed of the host vehicle M so that the speed becomes a speed corresponding to the hands-off (a speed based on the second speed plan) (step S206). Thereby, the process of one routine of the present flowchart ends.

Although an example in which the driving assistance device 100 controls the speed according to the driver's gripping state of the steering wheel 82 has been described in the above-described example (as in an example to be described below), an automated driving control device (not shown) may execute a similar process in addition to this (alternatively). The automated driving control device controls the speed and steering of the host vehicle M without depending on the driver's operation. The automated driving control device controls the speed in accordance with the driver's gripping state of the steering wheel 82 at the time of traveling on a curved road. For example, the automated driving control device causes the host vehicle M to travel at the first deceleration when the driver has gripped the steering wheel 82 or causes the host vehicle M to travel at the second deceleration (a speed less than the first deceleration) when the driver has not gripped the steering wheel 82. Thereby, the automated driving control device can implement automated driving consistent with the occupant' sense in automated driving and improve the comfort of the occupant. The automated driving control device is an example of a “control device.”

### [Control According to Deviation Between Target Speed and Object Speed]

The driving assistance device 100 may execute the following control. The driving assistance device 100 acquires a target speed during traveling on a curved road located in front of the host vehicle M and determines whether or not a speed of the host vehicle M or an object speed is less than or equal to a predetermined value with respect to the target speed, wherein the object speed is a set speed of automated speed control (e.g., a set speed of ACC) for automatically controlling the speed of the host vehicle M. When the object speed is less than or equal to the predetermined value with respect to the target speed, the driving assistance device 100 (the information provider 180) suppresses a process of causing the HMI 30 (the output device) to output information indicating a proposal for gripping the steering wheel of the host vehicle M to the driver of the host vehicle M. The suppression includes a process of preventing the information from being output and a process of weakening a degree of information output. The information provider 180 is an example of a “processor.”

As described above, the driving assistance device 100 causes the host vehicle M to travel on the curved road at a first speed (e.g., a first speed plan) when the host vehicle M travels on the curved road in a gripping state in which the driver is gripping the steering wheel, and causes the host vehicle M to travel on the curved road at a second speed (e.g., a second speed plan) lower than the first speed when the host vehicle M travels on the curved road in a non-gripping state in which the driver is not gripping the steering wheel. The target speed is a second speed or a speed based on the second speed corresponding to the above-described non-gripping state. The target speed may be a first speed corresponding to the above-described gripping state, a speed based on the first speed, or another speed.

The driver recognizer 120 determines whether or not the driver of the host vehicle M is gripping the steering wheel 82. The driver recognizer 120 determines the gripping of the steering wheel 82 on the basis of a detection result of the steering grip sensor 86 on the steering wheel 82.

### [Flowchart]

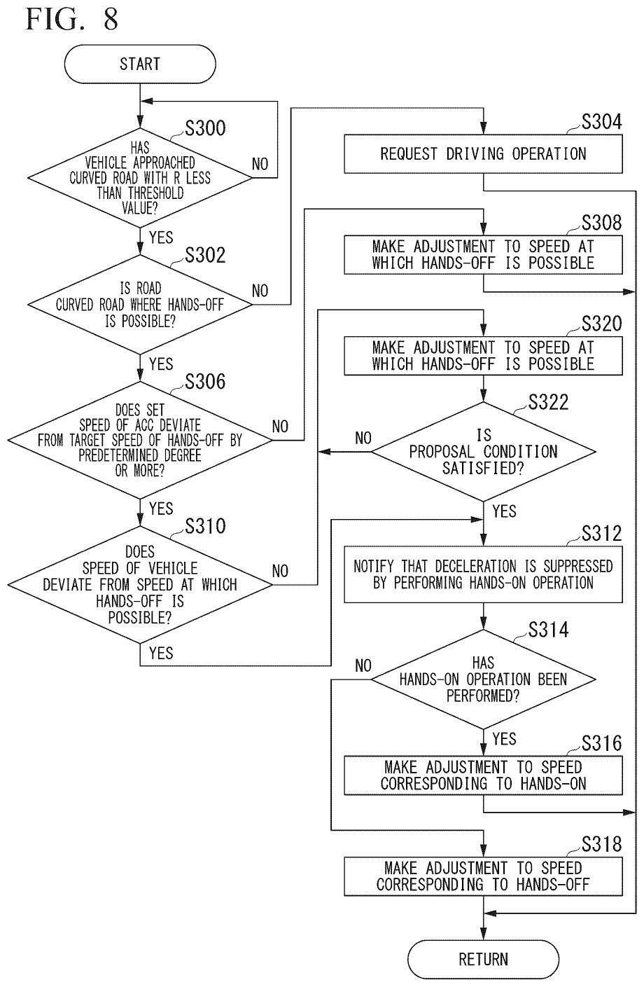

FIG. 8 is a flowchart showing an example of a flow of a process executed by the driving assistance device 100. First, the curve determiner 130 determines whether or not the host vehicle M has approached a curved road with R (a radius of a circle) of a curve less than a threshold value on the basis of a position of the host vehicle M and map information (step S300).

When the host vehicle M has approached the curved road with R of the curve less than the threshold value, the curve determiner 130 determines whether or not the approaching curved road is a curved road where the hands-off is possible (step S302). When the approaching curved road is not a curved road where the hands-off is possible, the driving assistance device 100 requests the driver to perform a driving operation via the HMI 30 (S304). When a notification of this request has been provided, the host vehicle M travels on a curved road by the driver's operation. Steps S300 to S304 are processing similar to steps S100 to S104.

When the approaching curved road is a curved road where the hands-off is possible, the driving assistance device 100 determines whether or not the set speed of the ACC deviates from a target speed of the hands-off (e.g., the target speed of the second speed plan) by a first threshold value or more (step S306). When the set speed of the ACC does not deviate from the target speed of the hands-off by a predetermined degree or more (when the difference between the set speed of the ACC and the target speed of the hands-off is small), the driving assistance device 100 suppresses the hands-on proposal and adjusts the speed of the host vehicle M to the speed of a case of traveling on the curved road in the hands-off on the basis of a timing when the speed adjustment starts (S308). Also, the process of one routine of the present flowchart ends. The first threshold value is, for example, a speed between 10 km/h and 25 km/h, for example, 15 km/h. In the above-described case, because the host vehicle M travels on the curved road at the set speed of the ACC set by the driver or at a speed close to the set speed, traveling is implemented without discomfort for the driver. For this reason, the hands-on proposal is suppressed.

Even if the set speed of the ACC is changed just before a predetermined distance from the entrance of the curved road or after passing through the entrance, the driving assistance device 100 does not proceed to the processing of step S308 when the determination of step S306 is positive.

When the set speed of the ACC deviates from the target speed of the hands-off by the first threshold value or more (e.g., when the set speed of the ACC is greater than the target speed and a difference between the set speed of the ACC and the target speed of the hands-off is large), the driving assistance device 100 determines whether or not the speed of the host vehicle M deviates from the target speed of the hands-off by the second threshold value or more (step S310). The second threshold value is a speed between 1 km/h and 10 km/h, for example, 5 km/h. In the above case, because the host vehicle M travels on the curved road at the speed of the host vehicle M or at a speed close to the speed of the host vehicle M, traveling is implemented without discomfort for the driver. For this reason, the hands-on proposal is suppressed.

As described above, the first and second threshold values are different speeds. A speed of the second threshold value is lower than that of the first threshold value. The first threshold value and the second threshold value may be the same speed.

The speed of the host vehicle M is, for example, a speed derived on the basis of the speed in a previous predetermined period. The speed of the host vehicle M is, for example, an average speed or a moving average speed in the previous predetermined period. Thereby, for example, even if the speed of the host vehicle M changes momentarily due to the deceleration of the preceding vehicle or the like, the inappropriate determination is suppressed.

When the speed of the host vehicle M deviates from the target speed of the hands-off by a second threshold value or more (e.g., the speed of the host vehicle M is higher than the target speed and a difference between the speed of the host vehicle M and the target speed of the hands-off is large), the driving assistance device 100 notifies the driver of the first proposal information indicating that deceleration is suppressed when the hands-on operation is performed (S312). Although the target speed of step S306 and the target speed of step S310 have been described as the same speed, the two target speeds may be different. Moreover, for one or both of the two target speeds, a speed different from the target speed of the hands-off may be set as the target speed.

Subsequently, the driving assistance device 100 determines whether or not the hands-on operation has been performed (S314). When the hands-on operation has been performed, the driving assistance device 100 adjusts the speed of the host vehicle M to the speed corresponding to the hands-on (S316). The driving assistance device 100, for example, controls the speed of the host vehicle M on the basis of the first speed plan. When the hands-on operation has not been performed, the driving assistance device 100 adjusts the speed of the host vehicle M to the speed corresponding to the hands-off (S318). The driving assistance device 100, for example, controls the speed of the host vehicle M on the basis of the second speed plan. Thereby, the process of one routine of the present flowchart ends.

When the speed of the host vehicle M does not deviate from the target speed of the hands-off by the second threshold value or more, the driving assistance device 100 suppresses the hands-on proposal and adjusts the speed of the host vehicle M to the speed of the case of traveling on the curved road in the hands-off on the basis of a timing when a speed adjustment starts (S320).

Subsequently, the driving assistance device 100 determines whether or not a proposal condition is satisfied (step S322). When the proposal condition is satisfied, the process proceeds to the processing of step S312. When the proposal condition is not satisfied, the process proceeds to step S320. The proposal condition is a condition under which the speed of the host vehicle M can be increased. That is, the driving assistance device 100 causes the HMI 30 to output information indicating a proposal for gripping the steering wheel of the host vehicle M to the driver of the host vehicle M if it is determined that a condition in which the speed of the host vehicle M can be increased is satisfied when the host vehicle M is traveling on the curved road after the process of causing the HMI 30 to output the information indicating the proposal for gripping the steering wheel of the host vehicle M to the driver of the host vehicle M is suppressed.

Proposal conditions are some or all of the following (1) to (3).
(1) There is a space for accelerating the host vehicle M and increasing the speed of the host vehicle M in front of the host vehicle M. For example, a traffic situation changes while the host vehicle M is traveling on the curved road and there is a situation in which there is no preceding vehicle or the preceding vehicle is separated from the host vehicle M.
(2) A distance from the position of the host vehicle M to the exit of the curved road is greater than or equal to a threshold value. If the above-described distance is less than the threshold value, when it is assumed that the hands-on proposal has been made and the driver has performed the hands-on operation, it is because the host vehicle M has reached the exit or has reached near the exit.
(3) The target speed when the steering wheel has been gripped by the driver is higher than the threshold value of the speed (the current speed) of the host vehicle M. In this case, the speed of the host vehicle M can be close to the target speed by accelerating the host vehicle M and increasing the speed.

When the proposal condition is satisfied as described above, the driving assistance device 100 can provide information corresponding to the situation to the occupant (e.g., the driver) of the host vehicle M by making a proposal for accelerating the host vehicle M and increasing the speed of the host vehicle M to the driver.

According to the process of the above-described flowchart, the driving assistance device 100 can provide information corresponding to the situation to the occupant of the host vehicle M. A part of the process of the above-described flowchart may be omitted. For example, the processing of step S306 or step S310 may be omitted.

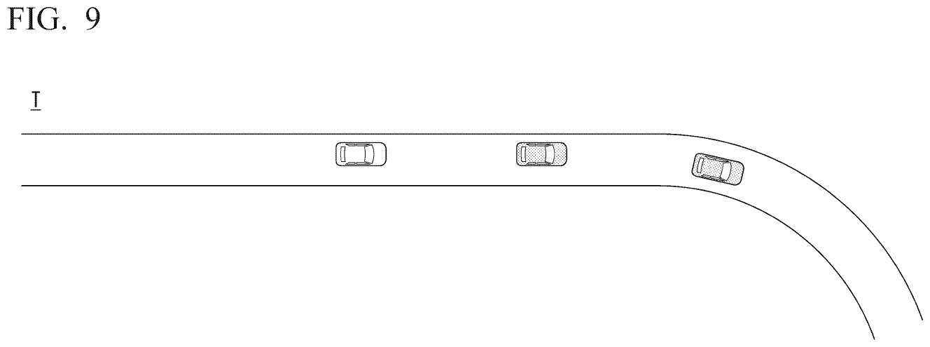

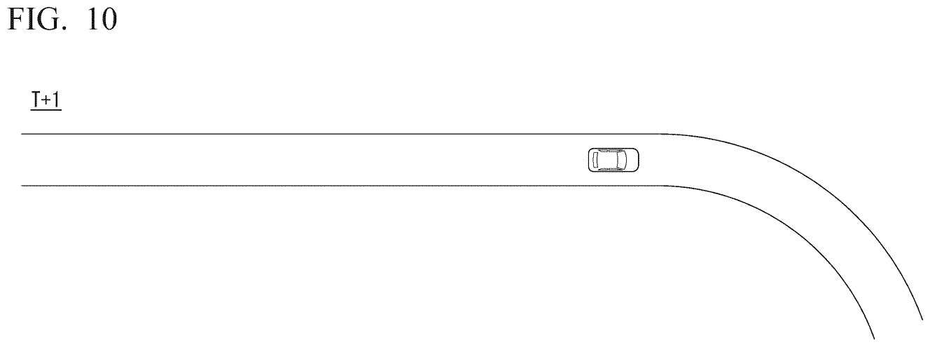

The processing of step S322 will be described with reference to FIGS. 9 and 10. As shown in FIG. 9, for example, when the road is congested at time T, the speed of the host vehicle M is slow and the speed of the host vehicle M may not deviate from the target speed of the hands-off. In this case, the process proceeds to the processing of steps S320 and S322. Thereafter, as shown in FIG. 10, the congestion is alleviated at time T+1, there is a space in front of the host vehicle M, the distance from the position of the host vehicle M to the exit of the curved road is greater than or equal to the threshold value, and the target speed when the steering wheel has been gripped is greater than the speed of the host vehicle M by a threshold value or more. In this case, the driving assistance device 100 makes a hands-on proposal to the driver, and the speed of the host vehicle M is increased when the driver performs the hands-on operation.

As described above, the driving assistance device 100 can perform appropriate control in accordance with a change in the situation.

According to the above-described embodiment, the driving assistance device 100 determines whether or not a speed of the host vehicle M or an object speed is less than or equal to a predetermined value with respect to the target speed, wherein the object speed is a set speed of automated speed control for automatically controlling the speed of the host vehicle M, and suppress a process of causing an output device to output information indicating a proposal for gripping the steering wheel of the host vehicle M to the driver of the host vehicle M when the object speed is less than or equal to the predetermined value with respect to the target speed. Thereby, the driving assistance device 100 can provide information corresponding to a situation to the occupant of the host vehicle M.

The embodiment described above can be represented as follows.

A control device including:
a storage device storing a program; and
a hardware processor, the hardware processor executing the program to execute steps of:
acquiring a target speed during traveling on a curved road located in front of a vehicle,
determining whether or not a speed of the vehicle or an object speed is less than or equal to a predetermined value with respect to the target speed, wherein the object speed is a set speed of automated speed control for automatically controlling the speed of the vehicle, and
suppressing a process of causing an output device to output information indicating a proposal for gripping a steering wheel of the vehicle to a driver of the vehicle when the object speed is less than or equal to the predetermined value with respect to the target speed.

Although modes for carrying out the present invention have been described above using embodiments, the present invention is not limited to the embodiments and various modifications and substitutions can also be made without departing from the scope and spirit of the present invention.

What is claimed is:

1. A control device comprising:
a storage medium storing computer-readable instructions; and
one or more processors connected to the storage medium, the processor executing the computer-readable instructions to:
acquire a target speed during traveling on a curved road located in front of a vehicle,
determine whether or not a speed of the vehicle or an object speed is less than or equal to a predetermined value with respect to the target speed, wherein the object speed is a set speed of automated speed control for automatically controlling the speed of the vehicle, and
suppress a process of causing an output device to output information indicating a proposal for gripping a steering wheel of the vehicle to a driver of the vehicle when the object speed is less than or equal to the predetermined value with respect to the target speed.

2. The control device according to claim 1,
wherein the processor executes the computer-readable instructions to:
cause the vehicle to travel on the curved road at a first speed when the vehicle travels on the curved road in a gripping state in which the driver is gripping the steering wheel, and
cause the vehicle to travel on the curved road at a second speed lower than the first speed when the vehicle travels on the curved road in a non-gripping state in which the driver is not gripping the steering wheel, and
wherein the target speed is the second speed corresponding to the non-gripping state or a speed based on the second speed.

3. The control device according to claim 2,
wherein the processor executes the computer-readable instructions to:
determine whether or not the set speed is greater than or equal to a first predetermined value with respect to the target speed,
determine whether or not the set speed is greater than or equal to a second predetermined value with respect to the target speed, and
suppress a process of causing the output device to output the information indicating the proposal for gripping the steering wheel of the vehicle to the driver of the vehicle when the set speed is not greater than or equal to the first predetermined value with respect to the target speed or when the set speed is not greater than or equal to the second predetermined value with respect to the target speed, and
wherein the first predetermined value and the second predetermined value are different speeds.

4. The control device according to claim 3, wherein the second predetermined value is a speed less than the first predetermined value.

5. The control device according to claim 1, wherein the speed of the vehicle is a speed derived on the basis of a speed in a previous predetermined period.

6. The control device according to claim 1, wherein the processor executes the computer-readable instructions to:
cause the output device to output the information indicating the proposal for gripping the steering wheel of the vehicle to the driver of the vehicle if it is determined that a condition in which the speed of the vehicle can be increased is satisfied when the vehicle is traveling on the curved road after the process of causing the output device to output the information indicating the proposal for gripping the steering wheel of the vehicle to the driver of the vehicle is suppressed.

7. The control device according to claim 6, wherein the condition is some or all of the following conditions:
(1) a condition in which there is a space for accelerating the vehicle and increasing the speed of the vehicle in front of the vehicle,
(2) a condition in which a distance from a position of the vehicle to an exit of the curved road is greater than or equal to a threshold value, and
(3) a condition in which a target speed of a case where the steering wheel has been gripped is greater than a target speed of a case where the steering wheel has not been gripped and the target speed of the case where the steering wheel has been gripped is greater than a current speed of the vehicle by a threshold value or more.

8. The control device according to claim 2, wherein the processor executes the computer-readable instructions to:
cause the output device to output the information indicating the proposal for gripping the steering wheel of the vehicle to the driver of the vehicle if it is determined that a condition in which the speed of the vehicle can be increased is satisfied when the vehicle is traveling on the curved road after the process of causing the output device to output the information indicating the proposal for gripping the steering wheel of the vehicle to the driver of the vehicle is suppressed.

9. The control device according to claim 8, wherein the condition is some or all of the following conditions:
(1) a condition in which there is a space for accelerating the vehicle and increasing the speed of the vehicle in front of the vehicle,
(2) a condition in which a distance from a position of the vehicle to an exit of the curved road is greater than or equal to a threshold value, and
(3) a condition in which a target speed of a case where the steering wheel has been gripped is greater than a target speed of a case where the steering wheel has not been gripped and the target speed of the case where the steering wheel has been gripped is greater than a current speed of the vehicle by a threshold value or more.

10. The control device according to claim 3, wherein the processor executes the computer-readable instructions to:
cause the output device to output the information indicating the proposal for gripping the steering wheel of the vehicle to the driver of the vehicle if it is determined that a condition in which the speed of the vehicle can be increased is satisfied when the vehicle is traveling on the curved road after the process of causing the output device to output the information indicating the proposal for gripping the steering wheel of the vehicle to the driver of the vehicle is suppressed.

11. The control device according to claim 10, wherein the condition is some or all of the following conditions:
(1) a condition in which there is a space for accelerating the vehicle and increasing the speed of the vehicle in front of the vehicle,
(2) a condition in which a distance from a position of the vehicle to an exit of the curved road is greater than or equal to a threshold value, and
(3) a condition in which a target speed of a case where the steering wheel has been gripped is greater than a target speed of a case where the steering wheel has not been gripped and the target speed of the case where the steering wheel has been gripped is greater than a current speed of the vehicle by a threshold value or more.

12. The control device according to claim 4, wherein the processor executes the computer-readable instructions to:
cause the output device to output the information indicating the proposal for gripping the steering wheel of the vehicle to the driver of the vehicle if it is determined that a condition in which the speed of the vehicle can be increased is satisfied when the vehicle is traveling on the curved road after the process of causing the output device to output the information indicating the proposal for gripping the steering wheel of the vehicle to the driver of the vehicle is suppressed.

13. The control device according to claim 12, wherein the condition is some or all of the following conditions:
(1) a condition in which there is a space for accelerating the vehicle and increasing the speed of the vehicle in front of the vehicle,
(2) a condition in which a distance from a position of the vehicle to an exit of the curved road is greater than or equal to a threshold value, and
(3) a condition in which a target speed of a case where the steering wheel has been gripped is greater than a target speed of a case where the steering wheel has not been gripped and the target speed of the case where the steering wheel has been gripped is greater than a current speed of the vehicle by a threshold value or more.

14. The control device according to claim 1, wherein the processor executes the computer-readable instructions to:
suppress the process of causing the output device to output the information indicating the proposal for gripping the steering wheel of the vehicle to the driver of the vehicle when the speed of the vehicle that is the object speed is greater than the target speed and less than or equal to a first predetermined value with respect to the target speed or when the set speed of the automated speed control for automatically controlling the speed of the vehicle is greater than the target speed and less than or equal to a second predetermined value with respect to the target speed, and
cause the output device to output the information indicating the proposal for gripping the steering wheel of the vehicle to the driver of the vehicle when the speed of the vehicle that is the object speed is greater than the target speed and exceeds the first predetermined value with respect to the target speed and further the set speed is greater than the target speed and exceeds the second predetermined value with respect to the target speed.

15. A control device comprising:
a storage medium storing computer-readable instructions; and
one or more processors connected to the storage medium, the processor executing the computer-readable instructions to:
execute a first determination process of determining whether or not a speed of a vehicle is greater than a target speed during traveling on a curved road located in front of the vehicle and exceeds a first predetermined value with respect to the target speed, a second determination process of determining whether or not a set speed of automated speed control for automatically controlling the speed of the vehicle is greater than the target speed and exceeds a second predetermined value with respect to the target speed, and a process of outputting information to a driver of the vehicle using an output device,
cause the vehicle to travel on the curved road at a first speed when the vehicle travels on the curved road in a gripping state in which the driver of the vehicle is gripping a steering wheel of the vehicle,
cause the vehicle to travel on the curved road at a second speed lower than the first speed when the vehicle travels on the curved road in a non-gripping state in which the driver is not gripping the steering wheel,
suppress a process of causing the output device to output information indicating a proposal for gripping the steering wheel of the vehicle to the driver of the vehicle when a result of the first determination process or a result of the second determination process is negative, and
cause the output device to output the information indicating the proposal for gripping the steering wheel of the vehicle to the driver of the vehicle when the result of the first determination process or the result of the second determination process is positive.

16. The control device according to claim 15, wherein the processor executes the computer-readable instructions to:
cause the vehicle to travel on the curved road at the first speed when the driver has gripped the steering wheel in accordance with the proposal, and
cause the vehicle to travel on the curved road at the second speed when the driver has not gripped the steering wheel without accepting the proposal.

17. A control method comprising:
acquiring, by a computer, a target speed during traveling on a curved road located in front of a vehicle,
determining, by the computer, whether or not a speed of the vehicle or an object speed is less than or equal to a predetermined value with respect to the target speed, wherein the object speed is a set speed of automated speed control for automatically controlling the speed of the vehicle, and
suppressing, by the computer, a process of causing an output device to output information indicating a proposal for gripping a steering wheel of the vehicle to a driver of the vehicle when the object speed is less than or equal to the predetermined value with respect to the target speed.
